(19) United States
(12) Patent Application Publication
(10) Pub. No.: US 2004/0066653 A1
(43) Pub. Date: Apr. 8, 2004

(54) Light bulbs

(75) Inventor: Si Wai Ho, Hong Kong (HK)

Correspondence Address: OSTROLENK FABER GERB & SOFFEN, 1180 AVENUE OF THE AMERICAS, NEW YORK, NY, 100368403

(73) Assignee: Star Leader Ltd

(21) Appl. No.: 10/265,566

(22) Filed: Oct. 3, 2002

(51) Int. Cl. F21V 14/00

(52) U.S. Cl. 362/255; 362/293

(57) ABSTRACT

A light bulb (2) has a glass-walled enclosure (4) with conventional filament (8) within the enclosure having current-supplying wires connected thereto and a layer of transparent or translucent plastics resin (14), such as an epoxy resin, overlying the glass (4).

### BACKGROUND OF THE INVENTION

The present invention relates to a light bulb provided with a protective coating and to a method of formation thereof.

Light bulbs of the type which have a clear or translucent enclosure in which a light-emitting electrical filament is enclosed are generally formed of glass, for reasons of high heat resistance, cost and ease of manufacture. Although glass is perfectly adequate for most applications, in situations where a light bulb is exposed to impact or fitted into some other apparatus or device which is potentially subjected to impact or other abusive stresses glass bulbs are liable to fracture. There are countless examples; one particular example is in strings of decorative lights such as are used on Christmas trees. Another example is in toys for children.

The present invention seeks to provide a filament-type light bulb which is of enhanced impact resistance.

### SUMMARY OF THE INVENTION

In a first aspect, the invention resides in an electric light bulb comprising a glass-walled enclosure and a filament within the enclosure having wires connected to opposite ends thereof, wherein the glass-walled enclosure is covered by a layer of a transparent or translucent plastics resin.

The plastics resin layer renders the light bulb considerably more resistant to impact, whilst still also adequately releasing the internally generated heat.

The plastics resin layer preferably totally encloses the glass-walled enclosure, with only wires making electrical connection to the filament protruding therethrough. The resin layer may coat the glass wall to a variety of different thickness as desired, but typically in a small bulb of say 1 cm in height the layer may be about 1 mm in thickness.

The plastics resin layer may be a wide variety of different materials, but preferably is a thermosetting plastics material.

A particularly preferred material is an epoxy resin, such being readily available, having good hardness qualities and being easily formable by curing at a moderate temperature. A particularly suitable epoxy resin is a polyether such as that formed from the polymerisation of bisphenol A and epichlorohydrin, such being readily commercially available.

In a further aspect the invention resides in a method of forming a plastics-coated light bulb comprising the steps of: a) providing a light bulb having a glass-walled enclosure containing a filament; b) filling a mould cavity with a curable plastics resin and inserting the light bulb into the cavity to coat the light bulb; c) maintaining the coated light bulb at an elevated temperature for a predetermined time to cure the resin. Prior to filling the mould cavity, the resin is generally pre-cured by maintaining at an elevated temperature for a predetermined time and allowing to cool.

### BRIEF INTRODUCTION TO THE DRAWINGS

An embodiment of the invention is now described, by way of example only, with reference to the following drawings in which:

FIG. 1 is a cross-sectional view of a coated bulb in accordance with an embodiment of the invention;

FIG. 2 shows two bulbs being coated within mould cavities in a mould ; and

FIGS. 3(a) to (i) illustrate the steps of forming a coated bulb.

### DETAILED DESCRIPTION OF THE PREFERRED EMBODIMENT

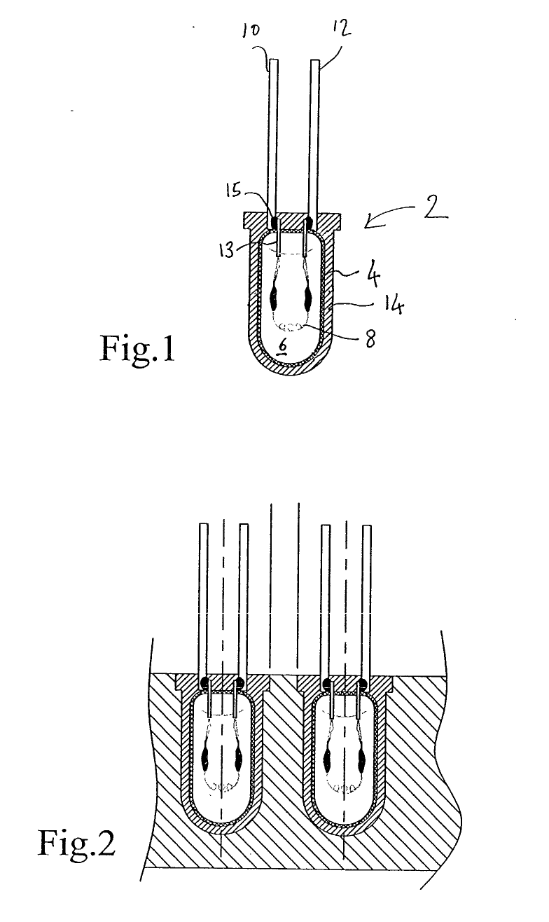

Turning to the drawings, FIG. 1 shows a light bulb in accordance with an embodiment of the invention.

The light bulb is generally designated 2 and comprises a conventional silica glass wall 4 defining therein an enclosure 6 housing a conventional wire filament 8 joined between a pair of current carrying wires 10, 12 through short wire portions 13 and a solder joint 15.

The illustrated bulb is of a simple, inexpensive and generally compact (for example, of 10 mm in height) design for use inside products such as children's toys although the invention has much wider applicability to bulbs of a wide variety of size, shape and use.

In accordance with the invention the bulb is provided with an outer protective layer 14 of a plastics resin material. As can be seen in FIG. 1 this layer 14 will generally have a thickness rather greater than the glass wall 4, fully enclosing the glass and with the wires 10, 12 protruding therefrom. A thickness in the region of 1 mm is found to be adequate for many applications.

A wide variety of plastics materials may be used, the requirements being that they produce transparent or translucent resins on curing. Preferably the resins are thermosetting resins made by polymerising a composition containing one or more suitable monomers using initiator, or by a self-polymerising reactive monomer species. Ideally, they should be curable within a convenient time/temperature range, and they should exhibit sufficient stability at elevated temperatures.

Various epoxy, novolac and epoxy-novolac resins are suitable with epoxy resins being particularly preferred for their wide availability, ease of use, and excellent properties of a high hardness and strength and low shrinkage during curing as well as being highly stable at elevated temperatures.

A particular epoxy resin material which is found to exhibit excellent properties, as well as being easy to apply and cure (as is discussed further below) is available commercially as WL-800A/B-1 epoxy resin of Guangzhou Wells Chemical Co Ltd. Another suitable material is the Egprime 2015 System of Eclat Chemical Co Ltd consisting of epichlorohydrin/bisphenol A-type epoxy resin (component A2015) with a hardener of methyl hexahydrophthalic anhydride (component B2015).

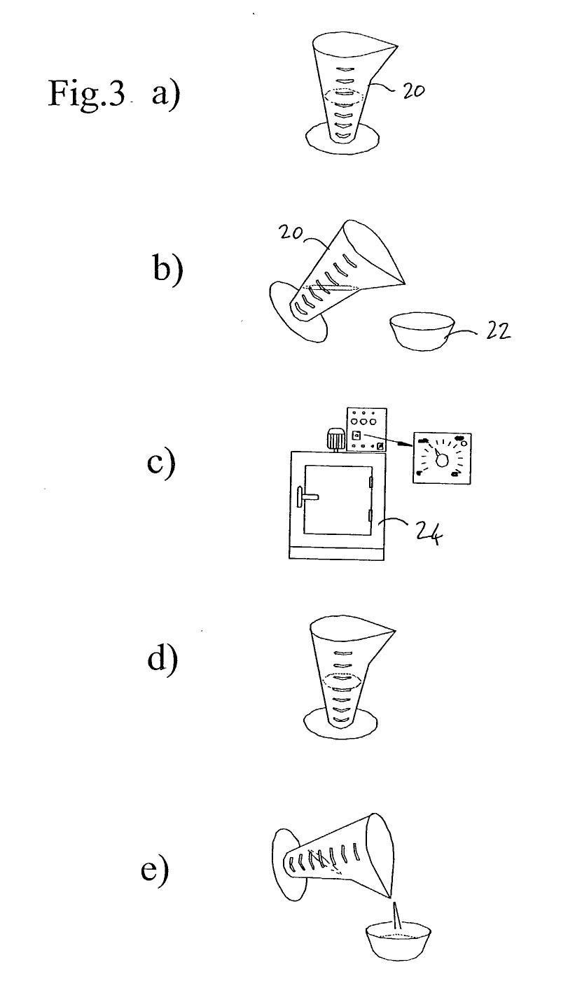

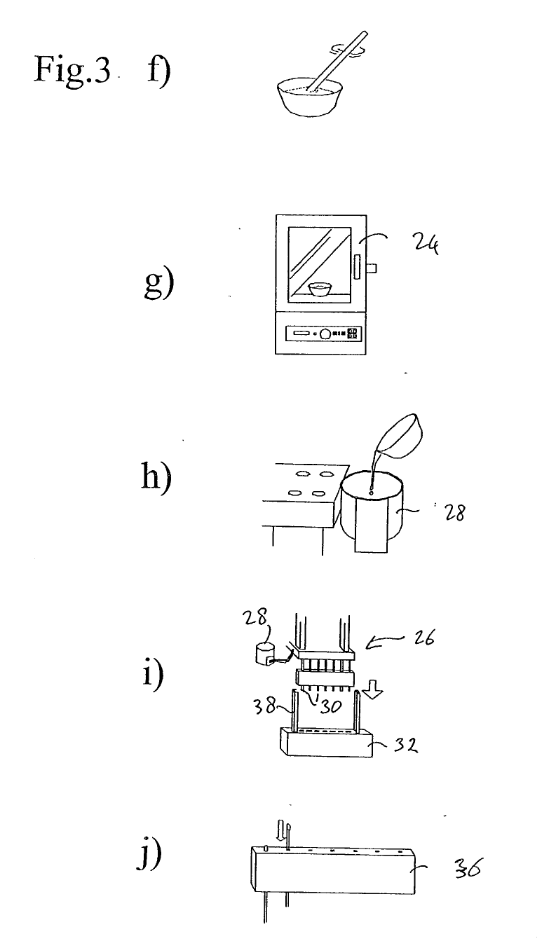

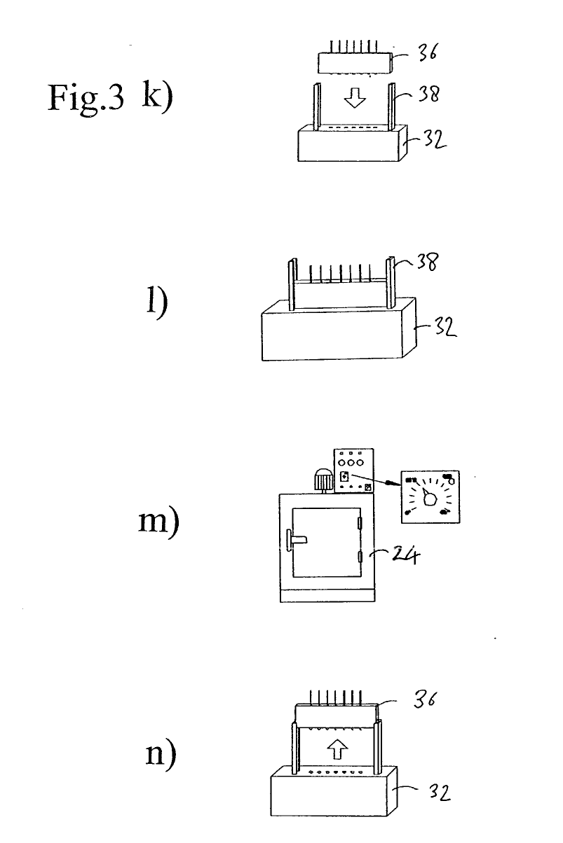

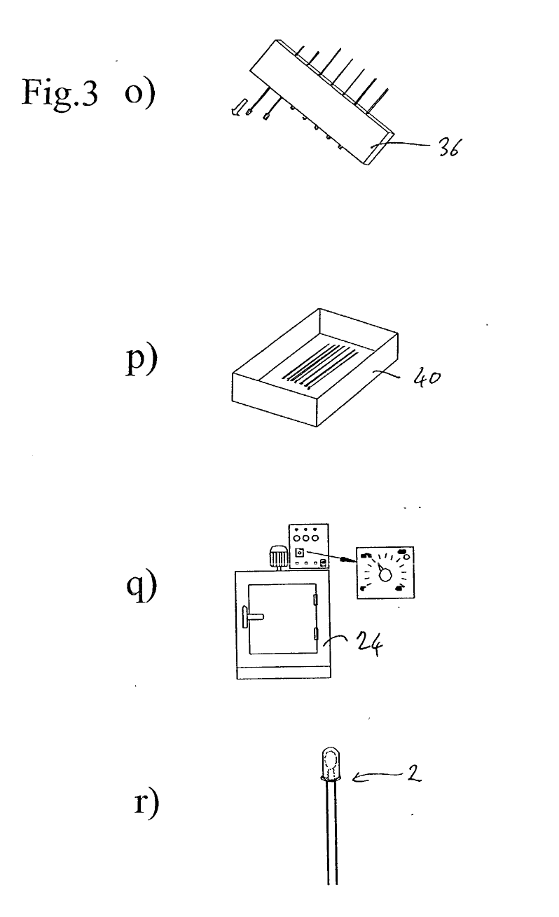

In the case of an epoxy resin of either of the types mentioned the resin is applied as follows, as is illustrated in FIGS. 3a) to r). The main epoxy resin component (FIG. 3a)) is measured in a measuring receptacle 20 then poured into a heat resistant receptacle 22 (FIG. 3b)) and placed in a heated oven 24 at about 120° for 14 minutes. The resin is allowed to cool and left at about 25-30° C. for few hours, about 4 hours generally being appropriate. An equal volume of hardener (FIG. 3d)) is then mixed with the resin (FIG. 3e)), stirred thoroughly (FIG. 3f)) and heated in an oven to pre-cure at between 120° and 130° C. for 10 minutes (FIG. 3g)).

The pre-cured mixture is then added to a liquid dispensing apparatus 26. This apparatus comprises a liquid reservoir 28 into which the mixture is poured. The apparatus serves to supply a precisely predetermined liquid volume to a series of nozzles 30 for injecting into a mould 32 having a series of mould cavities 34. More particularly FIG. 3i) shows the mould 32 having a linear array of cavities 34 beneath the series of aligned nozzles 30. The apparatus is activated to inject the resin into the mould.

The glass light bulbs to be coated are placed in a support 36 having a series of narrow openings allowing the connected wires to be pulled through, but not the glass bulbs, as shown in FIG. 3j), so that the bulbs protrude from the support 36. The support 36 is inverted and slid within guide arms 38 of the mould (FIG. 3k)) so the light bulbs extend into the mould cavities (FIG. 3l). The mould assembly is placed in the oven 24 at about 120-130° C. for about 30-40 minutes to cure the resin (FIG. 3m)).

After curing the support is removed from the mould (FIG. 3 n)) and the coated light bulbs removed from the openings (FIG. 3o)) and placed in a tray 40 (FIG. 3p)). The tray 40 is placed back in the oven for a final curing at again about 130° C. for about 5-6 hours (FIG. 3q)). The light bulbs are then removed and allowed to cool, at which point they are ready for use (FIG. 3r)).

The resultant epoxy resin-coated light bulbs have excellent impact resistance, as well as good thermal properties in that the internally generated heat can be adequately released, whilst the resin has good thermal stability over continued use. If desired, dyes can be added to the resin to change the colour and/or degree of light translucency.

1. An electric light bulb comprising a glass-walled enclosure and a filament within the enclosure having wires connected to opposite ends thereof, wherein the glass-walled enclosure is covered by a layer of a transparent or translucent plastics resin.

2. An electric light bulb wherein the plastics resin layer totally encloses the glass-walled enclosure.

3. An electric light bulb according to claim 1 wherein the plastics resin layer is about 1 mm thick.

4. An electric light bulb according to claim 1 wherein the plastics layer is an epoxy resin.

5. An electric light bulb according to claim 4 wherein the epoxy resin is a polyether.

6. An electric light bulb according to claim 5 wherein the epoxy resin is formed from the polymerisation of bisphenol A and epichlorohydrin.

7. A method of forming a plastics-coated light bulb comprising the steps of:
a) providing a light bulb having a glass-walled enclosure containing a filament;
b) filling a mould cavity with a curable plastics resin and inserting the light bulb into the cavity to coat the light bulb;
c) maintaining the coated light bulb at an elevated temperature for a predetermined time to cure the resin.

8. The method of claim 7 where the resin is an epoxy resin.

9. The method of claim 8 wherein the epoxy resin is a polyether.

10. The method of claim 7 wherein the epoxy resin is formed from the polymerisation of bisphenol A and epichlorohydrin.

11. The method of claim 7 wherein prior to filling the mould cavity, the resin is pre-cured by maintaining at an elevated temperature for a predetermined time and allowing to cool.
